(19) United States
(12) Patent Application Publication
(10) Pub. No.: US 2024/0419058 A1
(43) Pub. Date: Dec. 19, 2024

(54) PROJECTION SYSTEM, INSTALLATION UNIT, AND SUPPORT APPARATUS

(71) Applicant: SEIKO EPSON CORPORATION, Tokyo (JP)

(72) Inventor: Eita YAMAKI, Matsumoto-shi (JP)

(73) Assignee: SEIKO EPSON CORPORATION, Tokyo (JP)

(21) Appl. No.: 18/746,419

(22) Filed: Jun. 18, 2024

(30) Foreign Application Priority Data
Jun. 19, 2023 (JP) 2023-100200

(51) Int. Cl. G03B 21/14; G03B 21/60; G03B 37/04

(52) U.S. Cl. CPC G03B 21/14; G03B 21/60; G03B 37/04

(57) ABSTRACT

A projection system according to the present disclosure includes a first projector that projects image light onto a screen and a support apparatus. In the projection system, the support apparatus includes a cable holder that holds a cable having one end coupled to the first projector, and a support section that positions the cable holder with respect to an installation surface at which the first projector is provided, and in the upward vertical direction, the distance from the installation surface to the cable holder is greater than the distance from the installation surface to the top surface of the first projector.

The present application is based on, and claims priority from JP Application Serial Number 2023-100200, filed Jun. 19, 2023, the disclosure of which is hereby incorporated by reference herein in its entirety.

### BACKGROUND

### 1. Technical Field

The present disclosure relates to a projection system, an installation unit, and a support apparatus.

### 2. Related Art

JP-A-2021-188491 discloses a system in which a projector is housed in a box disposed outside a building and an image is projected from the projector toward a screen.

JP-A-2021-188491 is an example of the related art.

The system described above, in which the projector is disposed in a water field environment such as a bath, may cause a situation in which electricity leaks from the moisture or the like having adhered to the ground via a power supply cable or a LAN cable, or a viewer of an image projected by the projector is caught by a cable running on the ground.

### SUMMARY

To solve the problem described above, a projection system according to an aspect of the present disclosure includes a first projector that projects image light onto a screen and a support apparatus, the support apparatus including a cable holder that holds a cable having one end coupled to the first projector, and a support section that positions the cable holder with respect to an installation surface at which the first projector is provided, and in an upward vertical direction, a distance from the installation surface to the cable holder being greater than a distance from the installation surface to a top surface of the first projector.

An installation unit according to another aspect of the present disclosure is an installation unit to which a cable is coupled and in which a projector that projects image light is provided, the installation unit including an installation base having an installation surface at which the projector is provided, and a support apparatus that is coupled to the installation base and supports the cable, the support apparatus including a cable holder that holds the cable and a support section that positions the cable holder with respect to the installation surface, and in an upper vertical direction, a distance from the installation surface to the cable holder being greater than a distance from the installation surface to a top surface of the projector.

A support apparatus according to another aspect of the present disclosure is a support apparatus used in a projection system including a projector that projects image light onto a screen, the support apparatus including a cable holder that holds a cable having one end coupled to the projector, and a support section that positions the cable holder with respect to an installation surface at which the projector is provided, and in an upper vertical direction, a distance from the installation surface to the cable holder being greater than a distance from the installation surface to a top surface of the projector.

### BRIEF DESCRIPTION OF THE DRAWINGS

FIG. 1 is a schematic configuration diagram of a projection system according to an embodiment.

FIG. 2 is a perspective view showing a schematic configuration of an installation unit.

FIG. 3 is a perspective view showing the configuration of a support apparatus.

FIG. 4 is a side cross-sectional view showing a state in which the support apparatus is attached to an installation base.

FIG. 5 is a perspective view showing the configuration of an attachment section.

FIG. 6 is a cross-sectional view showing the configuration of key parts of a cable holder.

FIG. 7A is a cross-sectional view showing the configuration of key parts of the cable holder according to a first variation.

FIG. 7B is a cross-sectional view showing the configuration of key parts of the cable holder according to a second variation.

FIG. 7C is a cross-sectional view showing the configuration of key parts of the cable holder according to a third variation.

FIG. 8 shows a schematic configuration of the projection system according to a second embodiment.

FIG. 9 shows a schematic configuration of the projection system according to a third embodiment.

FIG. 10 shows a schematic configuration of the projection system according to a fourth embodiment.

### DESCRIPTION OF EMBODIMENTS

Embodiments of the present disclosure will be described below in detail with reference to the drawings. In the drawings used in the description below, a characteristic portion is enlarged for convenience in some cases for clarity of the characteristic thereof, and the dimension ratio and other factors of each component are therefore not always equal to actual values.

### First Embodiment

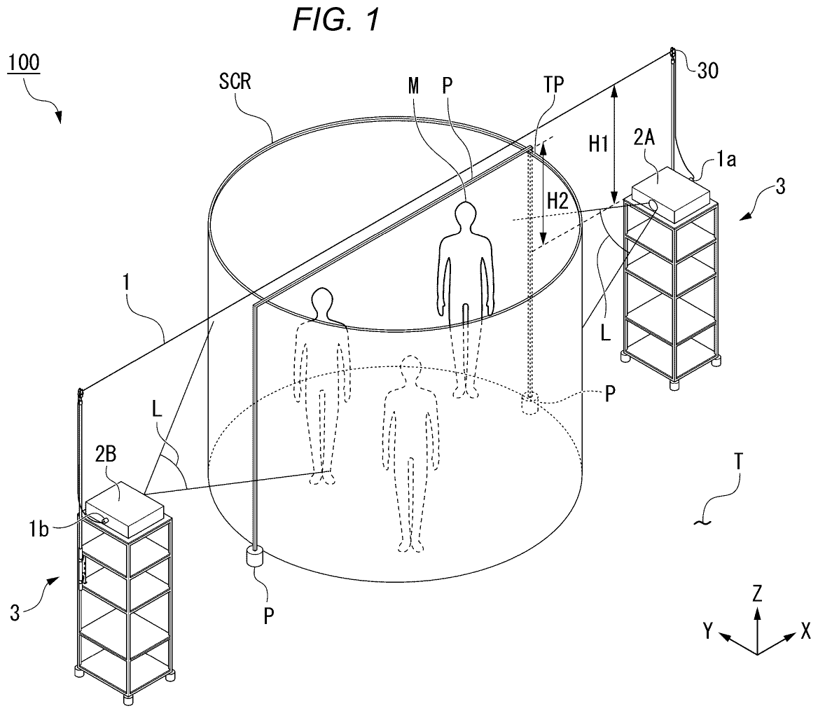

FIG. 1 is a schematic configuration diagram of a projection system 100 according to the present embodiment.

The projection system 100 according to the present embodiment includes a screen SCR, a screen frame P, a first projector 2A, a second projector 2B, a cable 1, and two installation units 3, as shown in FIG. 1.

The screen SCR in the present embodiment is so provided at a floor surface T that the screen frame P keeps the screen SCR cylindrical. The floor surface T corresponds to a surface of a floor of a room in a case where the projection system 100 is provided indoors, or corresponds to a surface of the ground in a case where the projection system 100 is provided outdoors.

The first projector 2A and the second projector 2B are disposed so as to face each other with the screen SCR therebetween. That is, the second projector 2B projects image light onto the screen SCR in a direction different from the direction in which the first projector 2A projects image light.

The first projector 2A projects image light L and the second projector 2B projects image light L toward the outer circumferential surface of the screen SCR, the two kinds of image light synchronizing with each other. That is, the image light L projected onto the screen SCR by the first projector 2A and the image light L projected onto the screen SCR by the second projector 2B as a whole generate a single image.

The first projector 2A and the second projector 2B are coupled to each other via the cable 1, which causes the image light L from the first projector 2A and the image light L from the second projector 2B to synchronize with each other. The cable 1 in the present embodiment is, for example, a LAN cable. One end 1a of the cable 1 is coupled to the first projector 2A, and the other end 1b of the cable 1 is coupled to the second projector 2B.

Based on the configuration described above, the projection system 100 according to the present embodiment allows viewers M inside the screen SCR to view an image displayed across the entire 360-degree circumference.

The first projector 2A and the second projector 2B are provided at the two respective installation units 3. The cable 1 bridges the space between the two installation units 3 so as to extend over the screen SCR. Therefore, in the projection system 100 according to the present embodiment, it is not necessary to route the cable 1 on the floor surface T.

The configuration of the installation units 3 will be subsequently described. The two installation units 3 have the same configuration. The configuration will be described below with reference to the installation unit 3 at which the first projector 2A is provided.

In the following description, an XYZ coordinate system shown in the drawings is used in some cases to describe the arrangement of the members of the projection system 100. In the drawings, the X-axis is an axis along the direction in which the first projector 2A projects the image light. The Y-axis is an axis perpendicular to the X-axis, and is an axis along the width direction of the screen onto which the image light is projected. The Z-axis is perpendicular to the X-axis and the Y-axis, and is an axis along the vertical direction and a normal to the floor surface T, at which the projection system 100 is provided.

In the present embodiment, for example, the opposite directions along the Z-axis are collectively referred to as a “vertical direction Z”, the direction toward the positive end of the direction Z is referred to as an “upper side”, and the direction toward the negative end of the direction Z is referred to as a “lower side”. The opposite directions along the X-axis are collectively referred to as a “forward-rearward direction X”, the direction toward the positive end of the direction X is referred to as a “front side”, and the direction toward the negative end of the direction X is referred to as a “rear side” in some cases. The opposite directions along the Y-axis are collectively referred to as a “rightward-leftward direction Y”, the direction toward the positive end of the direction Y is referred to as a “right side”, and the direction toward the negative end of the direction Y is referred to as a “left side”.

In the present embodiment, the rightward-leftward direction Y along the Y-axis corresponds to a “first direction”, the right side in the rightward-leftward direction Y corresponds to “one side in the first direction”, the left side in the rightward-leftward direction Y corresponds to “the other side in the first direction”, and the Z-axis direction along the vertical direction corresponds to a “second direction”. Note that the vertical direction Z, the frontward-rearward direction X, and the rightward-leftward direction Y are merely names for illustrating the arrangement of the component of the installation units 3, and do not specify the actual installation state or directions in which the components are disposed in the installation units 3.

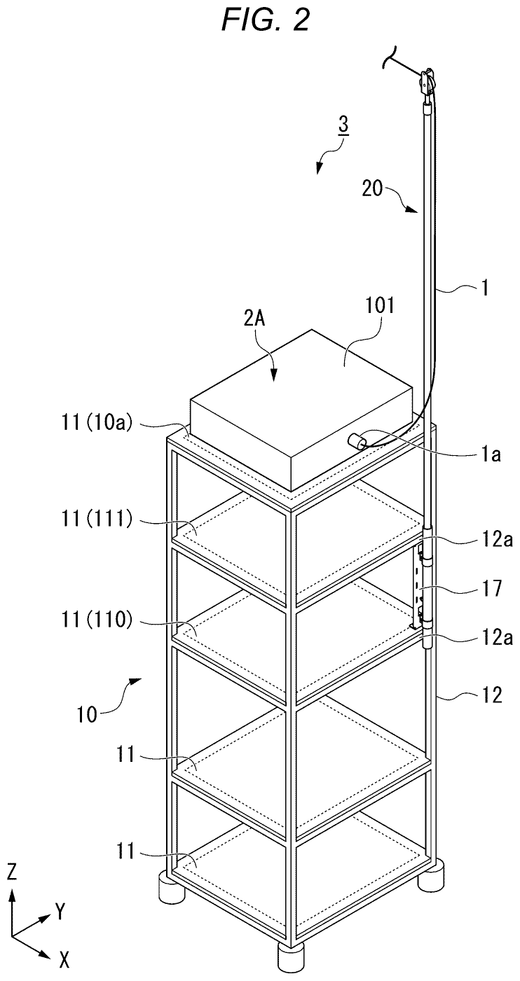

FIG. 2 is a perspective view showing a schematic configuration of the installation unit 3.

The installation unit 3 according to the present embodiment includes an installation base 10 and a support apparatus 20, as shown in FIG. 2. The installation base 10 has an installation surface 10a, at which the first projector 2A is provided. The support apparatus 20 supports the cable 1 upward with the one end 1a coupled to the first projector 2A and routed upward.

The installation base 10 includes a plurality of support plates 11, a frame part 12, which holds the plurality of support plates 11, and an attachment section 17. The support plates 11 are each formed of a plate having a predetermined strength, and is a wood plate in the present embodiment. The frame part 12 is made of metal and includes frame elements 12a, which hold the support plates 11. The attachment section 17 is a portion that detachably couples the support apparatus 20 to the installation base 10.

In the present embodiment, the support plates 11 and the frame elements 12a are so configured that the outer shape of each of the support plates 11 and the outer shape of the corresponding frame element 12a form a single surface in the plan view viewed in the vertical direction Z. The configuration described above in which each of the support plates 11 and the corresponding frame element 12a form a single surface allows improvement in the exterior appearance of the installation base 10.

The upper surface of each of the support plates 11 forms an installation surface at which the projector is provided. The installation base 10 in the present embodiment is provided with five support plates 11 in the vertical direction Z. The installation base 10 in the present embodiment thus allows the projector to be provided at any of the five heights in accordance with the application of the projection system. In FIG. 2, the first projector 2A is provided at the support plate 11 located at the uppermost tier in the vertical direction Z. In FIG. 2, the upper surface of the support plate 11 located at the uppermost tier therefore corresponds to the installation surface 10a, at which the first projector 2A is provided.

The configuration of the support apparatus 20 will be subsequently described.

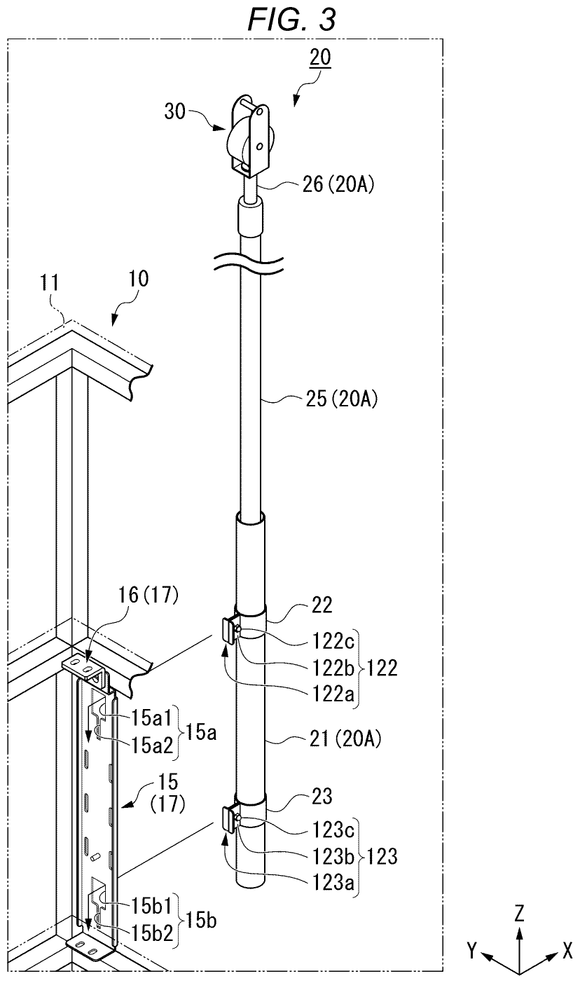

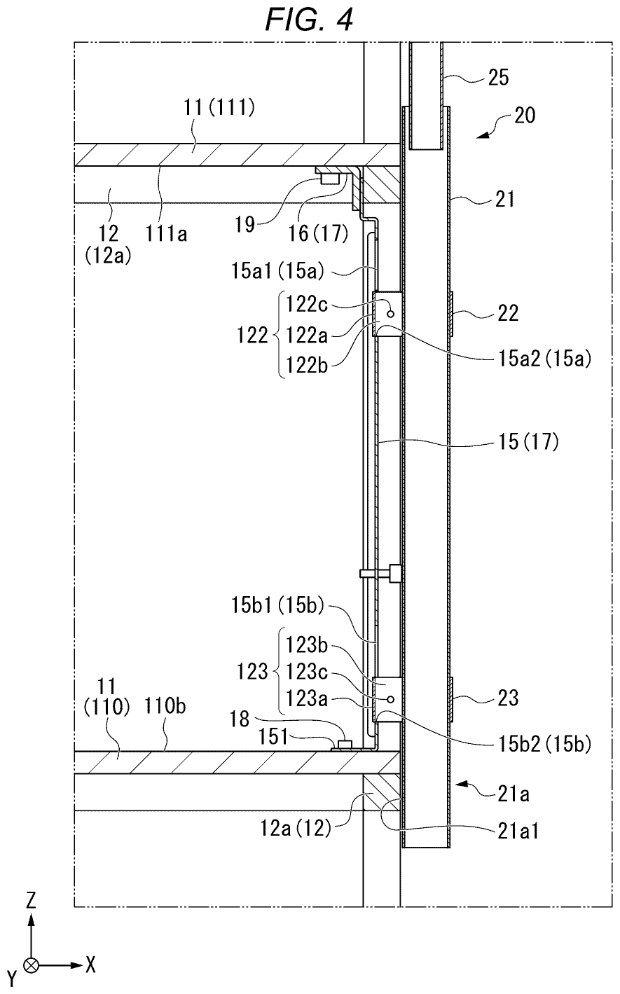

FIG. 3 is a perspective view showing the configuration of the support apparatus 20. FIG. 3 shows a state in which the support apparatus 20 is removed from the installation base 10 for clarity of the description. FIG. 4 is a side cross-sectional view showing a state in which the support apparatus 20 is attached to the installation base 10.

The support apparatus 20 includes a rod-shaped element 20A, which extends in the vertical direction Z, and a cable holder 30, as shown in FIG. 3. The rod-shaped element 20A includes a support section 21, a pole section 25, a spacer member 26, a first fixing section 22, and a second fixing section 23. The support section 21 is a columnar member, and is attached to the installation base 10 to position the cable holder 30 with respect to the installation surface 10a, at which the first projector 2A is provided. The support section 21 is a circular columnar member in the present embodiment, and may instead be a quadrangular columnar member or another polygonal columnar member. The pole section 25 is attached to the upper side of the support section 21 and is configured to be extendable in the vertical direction Z. The spacer member 26 is a spacer made of resin and used to attach the pole section 25 to the cable holder 30.

The support apparatus 20 is detachably coupled to the installation base 10. The support section 21 of the support apparatus 20 is attachable to and detachable from the attachment section 17 provided as a part of the installation base 10. Specifically, the support section 21 is detachably fixed to the attachment section 17 via the first fixing section 22 and the second fixing section 23. That is, the support apparatus 20 according to the present embodiment includes the first fixing section 22 and the second fixing section 23, which detachably fix the support section 21 to the installation base 10.

The first fixing section 22 and the second fixing section 23 are disposed at different positions in the vertical direction Z on the support section 21. Specifically, the first fixing section 22 is located above the second fixing section 23 in the configuration of the support section 21.

The first fixing section 22 is attached so as to be wound around the entire outer circumferential surface of the support section 21, and has a first protrusion 122. The first fixing section 22 is fixed to the outer circumferential surface of the support section 21, for example, with an adhesive.

The first protrusion 122 includes a pair of abutting sections 122b protruding in the radial direction of the support section 21, bent sections 122a, which are front end portions of the pair of abutting sections 122b bent at right angles, and a screw section 122c, which fastens the pair of abutting portions 122b to each other.

Similarly, the second fixing section 23 is attached so as to be wound around the entire outer circumferential surface of the support section 21, and has a second protrusion 123. The second fixing section 23 is fixed to the outer circumferential surface of the support section 21, for example, with an adhesive.

The second protrusion 123 includes a pair of abutting sections 123b protruding in the radial direction of the support section 21, bent sections 123a, which are front end portions of the pair of abutting sections 123b bent at right angles, and a screw section 123c, which fastens the pair of abutting portions 123b to each other.

The attachment section 17 includes a first bracket 15 and a second bracket 16. The first bracket 15 has the shape of a plate extending in the vertical direction Z, and has a first slit opening 15a and a second slit opening 15b formed along the vertical direction Z. The first slit opening 15a corresponds to the first protrusion 122 of the first fixing section 22, and the second slit opening 15b corresponds to the second protrusion 123 of the second fixing section 23.

The first slit opening 15a and the second slit opening 15b have the same shape. The shape of the first slit opening 15a will be described by way of example.

The first slit opening 15a is formed of the combination of a first opening 15al and a second opening 15a2 arranged in the vertical direction Z.

The length of the first opening 15al and the second opening 15a2 in the rightward-leftward direction Y is referred to as an opening width, and the height of the first opening 15al and the second opening 15a2 in the vertical direction z is referred to as an opening height. The opening width of the first opening 15al is greater than the opening width of the second opening 15a2. The opening width of the first opening 15al is greater than or equal to the width of the bent sections 122a of the first protrusion 122 in the rightward-leftward direction Y, and the opening height of the first opening is greater than or equal to the height of the bent sections 122a of the first protrusion 122 in the vertical direction Z. The bent sections 122a of the first protrusion 122 can therefore be inserted into the first opening 15a1 in the frontward-rearward direction X.

The opening width of the second opening 15a2 coupled to the lower side of the first opening 15al is smaller than the width of the bent sections 122a of the first protrusion 122 in the rightward-leftward direction Y, but is greater than or equal to the width of the pair of abutting sections 122b of the first protrusion 122 in the rightward-leftward direction Y. The first protrusion 122 is therefore slidable downward with the first protrusion 122 inserted into the first opening 15al and movable into the second opening 15a2. The first protrusion 122 is inserted into the second opening 15a2 with the bent sections 122a located at the rear side of the first bracket 15 (side facing negative end of direction X) and the screw section 122c, which fastens the pair of abutting portions 122b to each other, located at the front side of the first bracket 15 (side facing positive end of direction X). The gap in the frontward-rearward direction X between the bent sections 122a and the screw section 122c is desirably set at a value slightly greater than or equal to the thickness of the first bracket 15.

The opening height of the second opening 15a2 is greater than or equal to the height of the first protrusion 122 in the vertical direction Z. The entire bent sections 122a are therefore located at the rear side of the second opening 15a2 with the first protrusion 122 having slid until the lower ends of the pair of abutting sections 122b abut against the lower opening end of the second opening 15a2. In this state, the bent sections 122a abut against a portion around the second opening 15a2 of the first slit opening 15a, so that forward movement of the first protrusion 122 with respect to the first bracket 15 is restricted. Furthermore, the screw section 122c abuts against a portion around the second opening 15a2 of the first slit opening 15a, so that rearward movement of the first protrusion 122 with respect to the first bracket 15 is restricted.

The first protrusion 122 is thus hooked to the first slit opening 15a of the first bracket 15, so that the first fixing section 22 allows the support section 21 to be attached to the installation base 10. On the other hand, the first protrusion 122 is caused to slide upward and move into the first opening 15al of the first slit opening 15a, and the first protrusion 122 is then pulled forward out of the first slit opening 15a. The first fixing section 22 thus allows the support section 21 to be removed from the installation base 10.

The same applies to the relationship between the second protrusion 123 and the second slit opening 15b. That is, the bent sections 123a abut against a portion around a second opening 15b2 of the second slit opening 15b, so that forward movement of the second protrusion 123 with respect to the first bracket 15 is restricted. Furthermore, the screw section 123c abuts against a portion around the second opening 15b2 of the second slit opening 15b, so that rearward movement of the second protrusion 123 with respect to the first bracket 15 is restricted.

Therefore, the second protrusion 123 is hooked to the second slit opening 15b of the first bracket 15, so that the second fixing section 23 allows the support section 21 to be attached to the installation base 10. On the other hand, the second protrusion 123 is caused to slide upward and move into a first opening 15b1 of the second slit opening 15b, and the second protrusion 123 is then pulled forward out of the second slit opening 15b. The second fixing section 23 thus allows the support section 21 to be removed from the installation base 10.

Based on the configuration described above, in which the first fixing section 22 and the second fixing section 23 are hooked to the attachment section 17 of the installation base 10, the support apparatus 20 can be readily attached to and detached from the installation base 10, as shown in FIG. 4.

In the projection system 100 according to the present embodiment, in the vertical direction Z, the distance from the installation surface 10a, at which the first projector 2A is provided, to the cable holder 30 is greater than the distance from the installation surface 10a to a top surface 101 of the first projector 2A, as shown in FIG. 1. Furthermore, in the vertical direction z, the distance from the installation surface 10a to the cable holder 30 is greater than the distance from the installation surface 10a to a top surface 102 of the second projector 2B.

The top surface 101 of the first projector 2A corresponds to an upper surface of the exterior surface of the first projector 2A that faces the side opposite from the surface of the exterior surface that is in contact with the installation surface 10a of the installation base 10. Similarly, the top surface 102 of the second projector 2B corresponds to an upper surface of the exterior surface of the second projector 2B that faces the side opposite from the surface of the exterior surface that is in contact with the installation surface 10a of the installation base 10.

Let now a first distance H1 be the distance from each of the installation surfaces 10a to the cable holder 30 in the vertical direction Z, and a second distance H2 be the distance from the installation surface 10a to the position on the screen SCR that is farthest from the installation surface 10a in the vertical direction Z, that is, an upper end TP of the screen SCR. In the projection system 100 according to the present embodiment, the first distance H1 is greater than or equal to the second distance H2.

In the projection system 100 according to the present embodiment, it can in other words be said that the cable holder 30 is disposed at a location higher than each of the installation surfaces 10a, at which the projector is provided, more specifically, a location higher than or equal to the upper end TP of the screen SCR.

Therefore, in the projection system 100 according to the present embodiment, the cable 1, which couples the first projector 2A and the second projector 2B to each other, can be held above the screen SCR by the cable holder 30.

In the projection system 100 according to the present embodiment, the cable 1 is supported by each of the support apparatuses 20 in accordance with the procedure below.

First, the cable 1 is held by the cable holder 30 with the pole section 25 shown in FIG. 3 contracted and the length of the rod-shaped element 20A hence shortened. Subsequently, the support apparatus 20 holding the cable 1 is attached to the attachment section 17 of the installation base 10, and the pole section 25 is then extended and adjusted to any length to install the cable holder 30 at a predetermined height. The support apparatus 20 according to the present embodiment thus allows the cable holder 30 to be provided at any height without any work at an elevated location using a leg stand or the like.

A part of the outer circumferential surface of the support section 21 is in contact with the installation base 10 with the support apparatus 20 attached to the attachment section 17 of the installation base 10, as shown in FIG. 4.

An outer circumferential surface 21al of a lower end section 21a of the support section 21 is in contact with the frame element 12a of the frame part 12 of the installation base 10 with the support apparatus 20 attached to the attachment section 17 of the installation base 10. The configuration described above, in which the lower end section 21a of the support section 21 abuts against the frame part 12, allows further suppression of rattle of the support section 21.

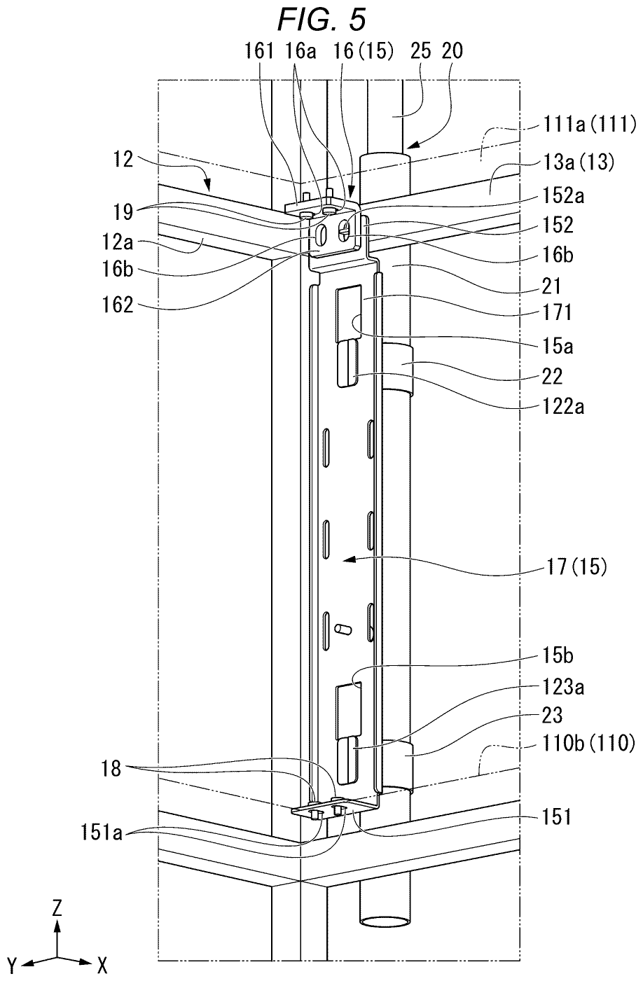

FIG. 5 is a perspective view showing the configuration of the attachment section 17.

The attachment section 17 is fixed to a pair of support plates 11 and the frame part 12 of the installation base 10, as shown in FIGS. 4 and 5. In the present embodiment, the attachment section 17 is fixed to a support plate 110 at the third tier counted from the bottom in the vertical direction Z, a support plate 111 at the fourth tier counted from the bottom in the vertical direction Z, and the frame element 12a of the frame part 12, which supports the support plate 111, as shown in FIG. 2.

The first bracket 15 of the attachment section 17 further includes a leg section 151 provided at the lower end in the vertical direction Z, and a contact section 152 provided at the upper end in the vertical direction Z.

The leg section 151 of the first bracket 15 is fixed to an upper surface 110b of the support plate 110 by screw members 18 shown in FIG. 4, as shown in FIG. 5. The leg section 151 has two screw holes 151a, through which the screw members 18 are inserted.

The contact section 152 of the first bracket 15 is in contact with an inner surface 13a of one columnar section 13, which constitutes the frame element 12a of the frame part 12 of the installation base 10. In the present embodiment, the columnar section 13 has a rectangular columnar shape extending in the rightward-leftward direction Y, and the inner surface 13a is a surface perpendicular to the installation surface 10a and facing the rear side in the frontward-rearward direction X. The first bracket 15 is therefore disposed perpendicularly to the installation surface 10a of the installation base 10.

The contact section 152 has a standing wall 152a, which stands toward the side opposite from the frame part 12 (rear side in frontward-rearward direction X). The standing wall 152a is, for example, the contact section 152 part of which is cut out and the remainder of which is bent. The standing wall 152a is used to position the first bracket 15 with respect to the second bracket 16, which will be described later.

The second bracket 16 is an L-shaped part that is a plate bent by 90 degrees. The second bracket 16 includes a first plate section 161 and a second plate section 162 perpendicular to each other. The second plate section 162 of the second bracket 16 is disposed so as to overlap with the contact section 152 of the first bracket 15. The second plate section 162 of the second bracket 16 has a pair of elongated holes 16b. The pair of elongated holes 16b are arranged along the rightward-leftward direction Y, and are each an elliptical opening having a major axis extending in the vertical direction Z.

One of the pair of elongated holes 16b corresponds to the standing wall 152a provided as a part of the contact section 152. Specifically, the width of each of the elongated holes 16b in the rightward-leftward direction Y coincides with the width of the standing wall 152a in the rightward-leftward direction Y. The second bracket 16 is therefore slidable in the vertical direction Z with the standing wall 152a inserted into the corresponding elongated hole 16b of the second plate section 162 so that the position of the second bracket 16 in the rightward-leftward direction Y is restricted with respect to the first bracket 15.

According to the configuration described above, in which the distance in the vertical direction Z between the first plate section 161 of the second bracket 16 and the leg section 151 of the first bracket 15 is adjustable, the attachment section 17 can be satisfactorily attached between the upper surface 110b of the support plate 110 and a rear surface 111a of the support plate 111, for example, even when the thicknesses of the support plates 110 and 111 are changed so that the distance between the upper surface 110b and the rear surface 111a changes.

The first plate section 161 of the second bracket 16 is fixed to the rear surface 111a of the support plate 111, which supports the first projector 2A, with screw members 19. The first plate section 161 has two screw holes 16a, through which the screw members 19 are inserted.

When the second bracket 16 to the rear surface 111a of the support plate 111 is fixed, the attachment section 17 is fixed with the contact section 152 of the first bracket 15 being in contact with the inner surface 13a of the columnar section 13.

The attachment section 17 is thus fixed with the second bracket 16 being in contact with the rear surface 111a of the support plate 111 and the contact section 152 of the first bracket 15 that is held by the second bracket 16 being in contact with the inner surface 13a of the columnar section 13. The rear surface 111a of the support plate 111 and the inner surface 13a of the columnar section 13 are surfaces perpendicular to each other. In the present embodiment, the rear surface 111a of the support plate 11 and the inner surface 13a of the columnar section 13 correspond to “a first surface and a second surface of the installation base that are perpendicular to each other”.

The attachment section 17 in the present embodiment is thus fixed to the rear surface 111a and the inner surface 13a, which are two surfaces perpendicular to each other in the installation base 10. The attachment section 17 is therefore attached to the installation base 10 in a stable state with little rattle. The attachment section 17 therefore allows the support apparatus 20 to be attached to the installation base 10 in the stable state without rattle.

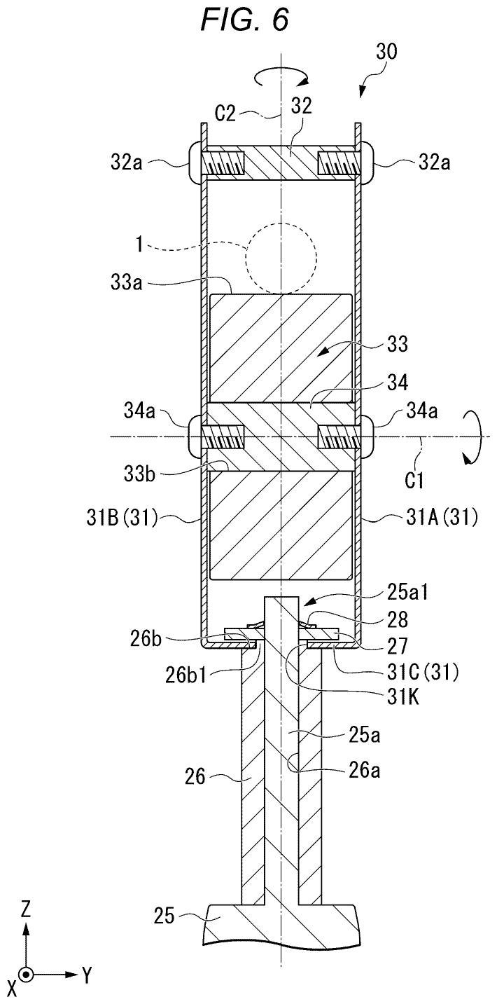

The configuration of the cable holder 30 will be subsequently described. The cable holder 30 holds the cable 1 coupled to the first projector 2A. FIG. 6 is a cross-sectional view showing the configuration of key parts of the cable holder 30.

The cable holder 30 includes a frame part 31, a coupler 32, a rotor 33, and a shaft 34, as shown in FIG. 6.

The frame part 31 has a substantially U-like cross-sectional shape. The frame part 31 includes a first extending section 31A, a second extending section 31B, and a bottom plate 31C. The first extending section 31A is a plate member located at the right side of the rotor 33 in the rightward-leftward direction Y and extending in the vertical direction Z. The second extending section 31B is a plate member located at the left side of the rotor 33 in the rightward-leftward direction Y and extending in the vertical direction Z. In the vertical direction Z, the first extending section 31A and the second extending section 31B protrude beyond the rotor 33 outward or toward the positive end of the direction Z. The bottom plate 31C is a plate member that extends in the rightward-leftward direction Y and couples the first extending section 31A and the second extending section 31B to each other. The bottom plate 31C couples portions of the first extending section 31A and the second extending section 31B that extend downward in the vertical direction Z to each other.

The cable holder 30 is attached to a front end section 25al of a support pin 25a provided at the upper end of the pole section 25 and extending in the vertical direction Z. The frame part 31 allows the front end section 25al of the support pin 25a to be inserted through an opening 31K provided through the bottom plate 31C.

The spacer member 26 is a spacer that maintains the frame part 31 and the pole section 25 in a predetermined positional relationship in the vertical direction Z. The spacer member 26 has a through hole 26a, through which the support pin 25a is inserted, and a pedestal 26b, which has a protrusion 26b1, which supports the bottom plate 31C and is inserted into the opening 31K. The front end section 25al of the support pin 25a, which is inserted into the through hole 26a, is disposed in the frame part 31 through the opening 31K, is inserted through a washer 27, and is fixed with a fixing member 28, which is formed, for example, of a push nut.

The frame part 31 is fixed to the pole section 25 in a state in which downward movement thereof in the vertical direction Z is restricted by the spacer member 26 and upward movement thereof in the vertical direction Z is restricted by the fixing member 28.

On the other hand, the frame part 31 is supported by the support pin 25a and the spacer member 26 so as to be rotatable around a second axis of rotation C2. The second axis of rotation C2 is an imaginary axis passing through the support pin 25a, and the second axis of rotation C2 passes through the center of the support pin 25a.

The rotor 33 is a disk-shaped member that rotates around a first axis of rotation C1. The rotor 33 has a holding surface 33a, which holds the cable 1. The holding surface 33a corresponds to the outer circumferential surface of the rotor 33, which has a circular columnar shape. The shaft 34 extends along the rightward-leftward direction Y and is inserted into a through hole 33b of the rotor 33, and both ends of the shaft 34 are fixed to the frame part 31 with bolts 34a. The shaft 34 rotatably holds the rotor 33 around the first axis of rotation C1. The first axis of rotation C1 is an imaginary axis passing through the shaft 34, and the first axis of rotation C1 passes through the center of the shaft 34.

According to the cable holder 30 in the present embodiment, for example, when the cable 1 is provided, the rotor 33 rotates as the cable 1 placed on the rotor 33 is pulled, so that a situation in which the cable 1 is twisted, rubbed, or otherwise stressed can be reduced. Problems, such as deformation or disconnection of the cable 1, can thus be suppressed.

Furthermore, since the frame part 31 is rotatable around the second axis of rotation C2, the direction in which the cable 1 is drawn by the cable holder 30 can be adjusted to a variety of directions.

In the cable holder 30 in the present embodiment, the first extending section 31A and the second extending section 31B protrude above the rotor 33. The configuration described above can suppress a problem such as a situation in which the cable 1 placed on the holding surface 33a of the rotor 33 moves in the rightward-leftward direction Y and comes off the holding surface 33a.

In the cable holder 30 in the present embodiment, portions of the first extending section 31A and the second extending section 31B that protrude upward in the vertical direction Z are coupled to each other via the coupler 32. The coupler 32 is disposed so as to be sandwiched between the first extending section 31A and the second extending section 31B, and couples the first extending section 31A and the second extending section 31B to each other with bolts 32a.

In the cable holder 30 in the present embodiment, the cable 1 is surrounded by the coupler 32, the first extending section 31A, the second extending section 31B, and the rotor 33. According to the configuration described above, the cable holder 30 can stably hold the cable 1 without causing the cable 1 to fall off.

As described above, the projection system 100 according to the present embodiment includes the first projector 2A, which projects the image light L onto the screen SCR, the second projector 2B, which projects the image light L onto the screen SCR in a direction different from the direction in which the first projector 2A projects the image light L, and the support apparatuses 20. The support apparatuses 20 each include the cable holder 30, which holds the cable 1 coupled to the first projector 2A and the second projector 2B, and the support section 21, which positions the cable holder 30 with respect to the installation surface 10a, at which the first projector 2A or the second projector 2B is provided. On the upper side in the vertical direction Z, the distance from the installation surface 10a to the cable holder 30 is greater than the distance from the installation surface 10a to the top surface 101 of the first projector 2A or the top surface 102 of the second projector 2B.

In the projection system 100 according to the present embodiment, the first distance H1 from the installation surface 10a to the cable holder 30 is greater than or equal to the second distance H2 from the installation surface 10a to the upper end TP of the screen SCR.

The projection system 100 according to the present embodiment, in which the cable holder 30 of the support apparatus 20 is disposed at a location higher than the installation surface 10a, at which the first projector 2A or the second projector 2B is provided, allows the cable 1 coupling the first projector 2A and the second projector 2B to each other to be held above the screen SCR.

The projection system 100 according to the present embodiment can therefore suppress contact of the cable 1 with the installation surface 10a of the installation base 10 or the floor surface T, at which the installation base 10 is provided.

Therefore, it can suppress a problem such as the viewers of an image are caught by the cable 1 routed on the floor surface T.

When the projection system 100 is used outdoors or in a similar situation, it is conceivable that moisture or the like has adhered to the floor surface T. Even in such a situation, since the cable 1 is not placed on the floor surface T, a problem such as leakage of electricity from the moisture having adhered to the floor surface T through the cable 1 can be suppressed.

One of the installation units 3 according to the present embodiment is an installation unit at which the first projector 2A, to which the cable 1 is coupled and which projects the image light L, is provided, and includes the installation base 10, which has the installation surface 10a, at which the first projector 2A is provided, and the support apparatus 20, which is coupled to the installation base 10 and supports the cable 1. The support apparatus 20 includes the cable holder 30, which holds the cable 1, and the support section 21, which positions the cable holder 30 with respect to the installation surface 10a. In the vertical direction Z, the distance from the installation surface 10a to the cable holder 30 is greater than the distance from the installation surface 10a to the top surface 101 of the first projector 2A.

The installation unit 3 according to the present embodiment, in which the cable holder 30 is disposed at a location higher than the installation surface 10a, at which the first projector 2A is provided, can suppress the situation in which the cable 1 coupled to the first projector 2A comes into contact with the installation surface 10a of the installation base 10 or the floor surface T, at which the installation base 10 is provided. Furthermore, even when moisture or the like has adhered to the floor surface T, at which the installation base 10 is provided, the installation unit 3 according to the present embodiment can suppress a problem such as leakage of electricity from the moisture having adhered to the floor surface T through the cable 1.

The support apparatus 20 according to the present embodiment is used in the projection system 100 including the first projector 2A, which projects the image light L onto the screen SCR, and includes the cable holder 30, which holds the cable 1 coupled to the first projector 2A, and the support section 21, which positions the cable holder 30 with respect to the installation surface 10a, at which the first projector 2A is provided. In the vertical direction Z, the distance from the installation surface 10a to the cable holder 30 is greater than the distance from the installation surface 10a to the top surface 101 of the first projector 2A.

The support apparatus 20 according to the present embodiment, in which the cable holder 30 is disposed at a location higher than the installation surface 10a, at which the first projector 2A is provided, can suppress the situation in which the cable 1 coupled to the first projector 2A comes into contact with the installation surface 10a of the installation base 10 or the floor surface T, at which the installation base 10 is provided. Furthermore, even when moisture or the like has adhered to the floor surface T, at which the installation base 10 is provided, the support apparatus 20 according to the present embodiment can suppress a problem such as leakage of electricity from the moisture having adhered to the floor surface T through the cable 1.

### First Variation

A first variation of the projection system 100 according to the first embodiment will be subsequently described. The difference between the present variation and the projection system 100 is the configuration of the cable holder of the support apparatus, and other configurations are the same. Therefore, the configuration of the cable holder will be described below, and the other configurations will not be described.

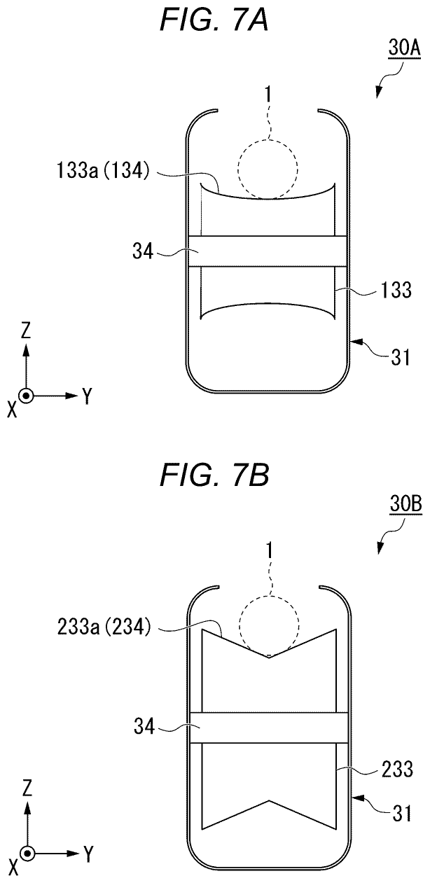

FIG. 7A is a cross-sectional view showing the configuration of key parts of the cable holder according to the present variation. In FIG. 7A, members that will not be used in the description are omitted or shown in simplified forms.

A cable holder 30A according to the present variation includes the frame part 31, the coupler 32, a rotor 133, and the shaft 34, as shown in FIG. 7A.

The rotor 133 has a holding surface 133a, which holds the cable 1. In the present variation, the holding surface 133a of the rotor 133 has a recess 134, which is recessed toward the shaft 34 in the cross-sectional view taken along the plane YZ containing the rightward-leftward direction Y and the vertical direction Z. The recess 134 is provided at the entire outer circumferential surface of the rotor 133 continuously in the circumferential direction.

In the present variation, the entire holding surface 133a is formed of the recess 134. The surface of the recess 134 is a curved surface having a curvature defined with respect to the first axis of rotation C1 of the rotor 133. The cable 1 has a circular cross-sectional shape.

The cable holder 30A according to the present variation stably holds the cable 1, which has a circular cross-sectional shape, along the surface of the recess 134 having a curved surface. Therefore, even when the rotor 133 rotates, a shift of the cable 1 in the rightward-leftward direction Y along the shaft 34 can be suppressed. The situation in which the cable 1 is rubbed due to contact between the cable 1 and the frame part 31 can therefore be suppressed.

### Second Variation

A second variation of the projection system 100 according to the first embodiment will be subsequently described. The difference between the present variation and the projection system 100 is the configuration of the cable holder of the support apparatus, and other configurations are the same. Therefore, the configuration of the cable holder will be described below, and the other configurations will not be described.

FIG. 7B is a cross-sectional view showing the configuration of key parts of the cable holder according to the present variation. In FIG. 7B, members that will not be used in the description are omitted or shown in simplified forms.

A cable holder 30B according to the present variation includes the frame part 31, the coupler 32, a rotor 233, and the shaft 34, as shown in FIG. 7B.

The rotor 233 has a holding surface 233a, which holds the cable 1. In the present variation, the holding surface 233a of the rotor 233 has a recess 234, which is recessed toward the shaft 34 in the cross-sectional view taken along the plane YZ containing the rightward-leftward direction Y and the vertical direction Z. In the present variation, the entire holding surface 233a is formed of the recess 234. The recess 234 is a groove having a V-like cross-sectional shape. That is, the recess 234 is provided at the entire outer circumferential surface of the rotor 233 continuously in the circumferential direction.

The cable holder 30B according to the present variation, which stably holds the cable 1 in the recess 234, can suppress a shift of the cable 1 in the rightward-leftward direction Y along the shaft 34 even when the rotor 233 rotates. In present variation, since the recess 234 is a V-shaped groove, a shift of the cable 1 in the rightward-leftward direction Y is more readily restricted. The cable 1 is therefore less likely to come into contact with the frame part 31.

### Third Variation

A third variation of the projection system 100 according to the first embodiment will be subsequently described. The difference between the present variation and the projection system 100 is the configuration of the cable holder of the support apparatus, and other configurations are the same. Therefore, the configuration of the cable holder will be described below, and the other configurations will not be described.

FIG. 7C is a cross-sectional view showing the configuration of key parts of the cable holder according to the present variation. In FIG. 7C, members that will not be used in the description are omitted or shown in simplified forms.

A cable holder 30C according to the present variation includes the frame part 31, the coupler 32, a rotor 333, and the shaft 34, as shown in FIG. 7C.

The rotor 333 has a holding surface 333a, which holds the cables 1. In the present variation, the holding surface 333a of the rotor 333 has two recesses 334, which are recessed toward the shaft 34 in the cross-sectional view taken along the plane YZ containing the rightward-leftward direction Y and the vertical direction Z. The recesses 334 are each a groove having a V-shaped cross-sectional shape. That is, the difference between the present variation and the second variation is that the rotor has a plurality of recesses.

The cable holder 30C according to the present variation can stably hold two cables 1 in the respective two recesses 334. That is, the cable holder 30C according to the present variation is a single cable holder that can hold two cables 1.

The present variation has been described with reference to the case where two recesses 334 are provided, and three or more recesses 334 may be provided in accordance with the number of cables 1.

### Second Embodiment

The projection system according to a second embodiment will be subsequently described. The same components as those of the projection system 100 according to the first embodiment hereinafter have the same reference characters, and the description of the same components will be partially simplified or omitted.

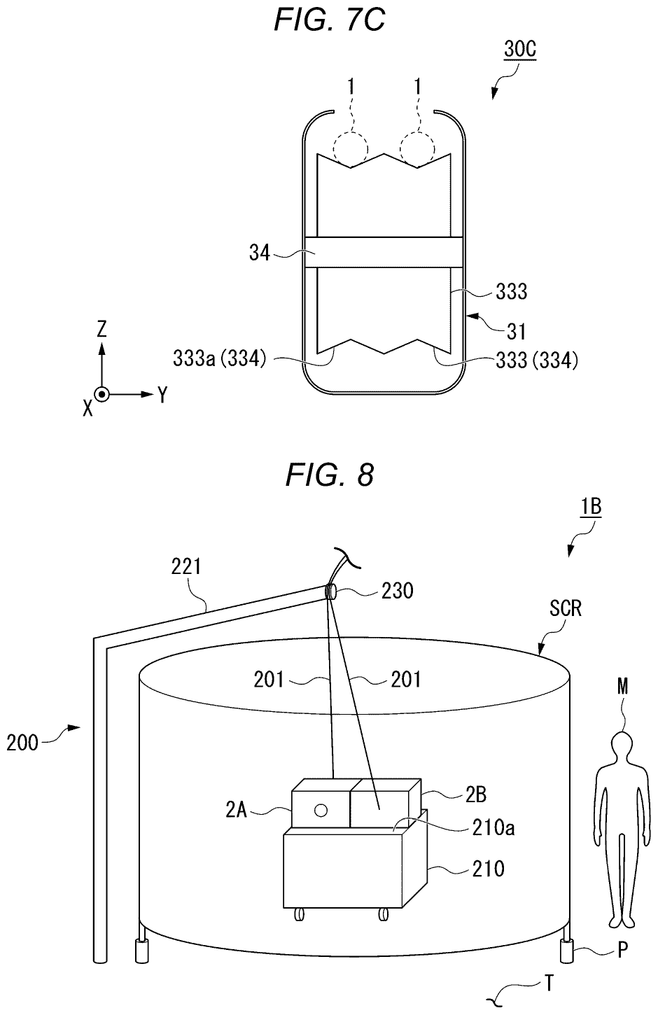

FIG. 8 shows a schematic configuration of a projection system 1B according to the present embodiment.

The projection system 1B according to the present embodiment includes the cylindrical screen SCR, the screen frame P, the first projector 2A, the second projector 2B, cables 201, an installation base 210, and a support apparatus 200, as shown in FIG. 8.

The installation base 210 has an installation surface 210a, at which the first projector 2A and the second projector 2B are provided. The first projector 2A and the second projector 2B are disposed inside the screen SCR so as to face opposite sides. That is, the second projector 2B projects image light onto the inner side of the screen SCR in a direction different from the direction in which the first projector 2A projects image light. The first projector 2A projects image light and the second projector 2B projects image light toward the inner peripheral surface of the screen SCR, the two kinds of image light synchronizing with each other.

Based on the configuration described above, the projection system 1B according to the present embodiment allows the viewers M outside the screen SCR to view an image displayed across the entire 360-degree circumference.

The support apparatus 200 supports two cables 201 at upper side thereof, one cable 201 having one end coupled to the first projector 2A and the other cable 201 having one end coupled to the second projector 2B. The cables 201 in the present embodiment are, for example, each a power supply cable, and the other end of each of the cables 201 is coupled to a power supply apparatus that is not shown but is located outside the screen SCR.

The support apparatus 200 includes a cable holder 230, which has the same structure as that of the cable holder 30 in the first embodiment, and a support section 221, which positions the cable holder 230 with respect to the installation surface 210a. The support section 221 is a substantially L-shaped support column, is disposed so as to extend from the exterior of the screen SCR toward the interior thereof, and has a tip that supports the cable holder 230.

In the projection system 1B according to the present embodiment, in the vertical direction Z, the distance from the installation surface 210a, at which the first projector 2A and the second projector 2B are provided, to the cable holder 230 is greater than the distance from the installation surface 210a to the top surface 101 of the first projector 2A and the top surface 102 of the second projector 2B. Therefore, in the projection system 1B according to the present embodiment, the cables 201, which are coupled to the first projector 2A and the second projector 2B, can be held above the screen SCR by the cable holder 230.

The projection system 1B according to the present embodiment can suppress contact of the cables 201 with the installation surface 210a of the installation base 210 or the floor surface T, at which the installation base 210 is provided. Therefore, it can suppress a problem such as the viewers of an image are caught by the cables 201 routed on the floor surface T. Also when the projection system 1B is used outdoors or in a similar situation, since the cables 201 are not placed on the floor surface T, the problem of leakage of electricity from the moisture having adhered to the floor surface T through the cables 201 can be suppressed.

### Third Embodiment

The projection system according to a third embodiment will be subsequently described. The same components as those of the projection system 100 according to the first embodiment hereinafter have the same reference characters, and the description of the same components will be partially simplified or omitted.

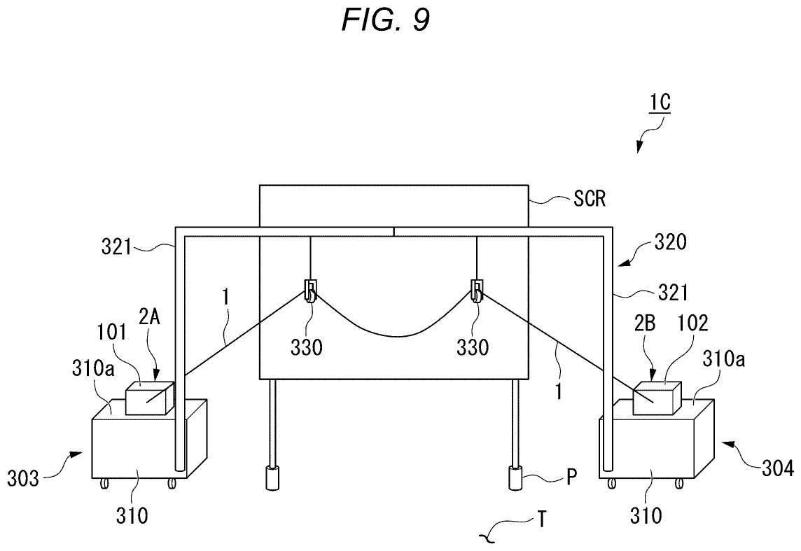

FIG. 9 shows a schematic configuration of a projection system 1C according to the present embodiment.

The projection system 1C according to the present embodiment includes a rectangular screen SCR, the screen frame P, the first projector 2A, the second projector 2B, the cable 1, and two installation units 303 and 304, as shown in FIG. 9.

The first projector 2A projects image light and the second projector 2B projects image light from different positions in front of the screen SCR toward the screen SCR, the two kinds of image light synchronizing with each other.

The first projector 2A and the second projector 2B are provided at the two installation units 303 and 304, respectively.

The installation unit 303, at which the first projector 2A is provided, includes an installation base 310 and a support apparatus 320. The installation base 310 has an installation surface 310a, at which the first projector 2A is provided.

The support apparatus 320 includes a cable holder 330, which has the same structure as that of the cable holder 30 in the first embodiment, and a support section 321, which positions the cable holder 330 with respect to the installation surface 310a. The support section 321 is a substantially L-shaped support column, extends upward from the installation base 310, is bent toward the second projector 2B, and has a tip that supports the cable holder 330.

The installation unit 304, at which the second projector 2B is provided, has the same configuration as that of the installation unit 303. The installation unit 304 includes the installation base 310 and the support apparatus 320. The support apparatus 320 includes the cable holder 330 and the support section 321. In the installation unit 304, the support section 321, which is formed of a substantially L-shaped support column, extends upward from the installation base 310, is bent toward the first projector 2A, and has a tip that supports the cable holder 330. The installation units 303 and 304 are so disposed side by side in the direction along the width direction of the screen SCR that the tips of the support sections 321 abut against each other.

In the projection system 1C according to the present embodiment, in the vertical direction Z, the distance from the installation surfaces 310a, at which the first projector 2A and the second projector 2B are provided, to the cable holders 330 is greater than the distance from the installation surfaces 310a to the top surface 101 of the first projector 2A and the top surface 102 of the second projector 2B. Therefore, in the projection system 1C according to the present embodiment, the cable 1, which couples the first projector 2A and the second projector 2B to each other, is held above the installation surfaces 310a by the cable holders 330.

The projection system 1C according to the present embodiment can suppress contact of the cable 1 with the installation surfaces 310a of the installation bases 310 or the floor surface T, at which the installation bases 310 are provided. Therefore, it can suppress a problem such as the viewers of an image are caught by the cable 1 routed on the floor surface T. Also when the projection system 1C is used outdoors or in a similar situation, since the cable 1 is not placed on the floor surface T, the problem of leakage of electricity from the moisture having adhered to the floor surface T through the cable 1 can be suppressed.

In the present embodiment, the support apparatus 320 may hold the cable 1 above the screen SCR. The support sections 321 of the installation units 303 and 304 may be integrated with each other.

### Fourth Embodiment

The projection system according to a fourth embodiment will be subsequently described. The same components as those of the projection system 100 according to the first embodiment hereinafter have the same reference characters, and the description of the same components will be partially simplified or omitted.

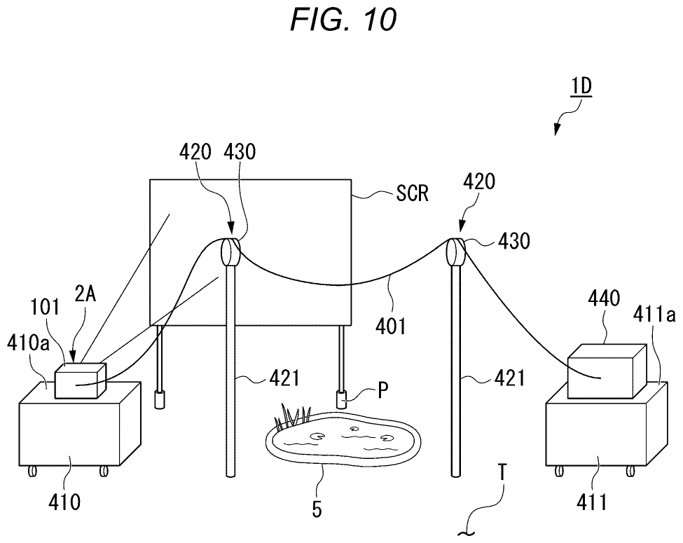

FIG. 10 shows a schematic configuration of a projection system 1D according to the present embodiment.

The projection system 1D according to the present embodiment includes the rectangular screen SCR, the screen frame P, the first projector 2A, a cable 401, a first installation base 410, a pair of support apparatuses 420, a second installation base 411, and a battery apparatus 440, as shown in FIG. 10.

Since the projection system 1D according to the present embodiment is used outdoors, for example, a water field 5 such as a pond is present around the projection system 1D.

The first installation base 410 has an installation surface 410a, at which the first projector 2A is provided. The second installation base 411 has an installation surface 411a, at which the battery apparatus 440 is provided. The cable 401 in the present embodiment is, for example, a power supply cable, has one end coupled to the first projector 2A, and the other end coupled to the battery apparatus 440. The first projector 2A is therefore operable also outdoors by the power supplied from the battery apparatus 440. The battery apparatus 440, which serves as a power supply, may, for example, be a portable mobile battery, a portable power supply, or an electric vehicle.

The pair of support apparatuses 420 each include a cable holder 430, which has the same structure as that of the cable holder 30 in the first embodiment, and a support section 421, which positions the cable holder 430 with respect to the installation surface 410a. The support section 421 is a support column extending in the vertical direction Z, and has a tip that supports the cable holder 430.

In the projection system 1D according to the present embodiment, in the vertical direction Z, the distance from the installation surface 410a, at which the first projector 2A is provided, to the cable holder 430 is greater than the distance from the installation surface 410a to the top surface 101 of the first projector 2A. Therefore, in the projection system 1D according to the present embodiment, the cable 401, which has one end coupled to the first projector 2A and the other end coupled to the battery apparatus 440, is held above the installation surfaces 410a and 411a by the cable holders 430.

The projection system 1D according to the present embodiment can suppress contact of the cable 401 with the installation surface 410a of the first installation base 410 or the floor surface T, at which the first installation base 410 is provided. Therefore, it can suppress a problem such as the viewers of an image are caught by the cable 401 routed on the floor surface T. Since the projection system 1D according to the present embodiment is used outdoors where the water field 5 is present, moisture in the water field 5 may have adhered to the floor surface T. In contrast, in the projection system 1D according to the present embodiment, since the cable 401 is not placed on the floor surface T, the problem of leakage of electricity from the moisture having adhered to the floor surface T through the cable 401 can be suppressed.

In the present embodiment, the support apparatus 420 may hold the cable 401 above the screen SCR.

The technical scope of the present disclosure is not limited to the embodiments described above, and a variety of changes can be made thereto to the extent that the changes do not depart from the intent of the present disclosure. An aspect of the present disclosure can be achieved by an appropriate combination of the characteristic portions in the embodiments described above.

The aforementioned embodiments and variations thereof have been described with reference to the case where the first projector 2A or the second projector 2B is provided on an installation base, and the first projector 2A or the second projector 2B may be used with the projector directly provided at the floor surface. In this case, the installation surface at which the projector is provided is the floor surface.

The aforementioned embodiments and variations thereof have been described with reference to the case where an image is projected onto the screen SCR by using two or a fewer number of projectors, and an image may be projected onto the screen by using three or a greater number of projectors.

The aforementioned embodiments and variations thereof have been described with reference to the case where the two projectors each project the image light synchronizing with each other toward the screen SCR, and one of the two projectors may project image light toward the screen SCR and the other may project different image light toward the screen SCR.

### SUMMARY OF PRESENT DISCLOSURE

The present disclosure will be summarized below as additional remarks.

### Additional Remark 1

A projection system including a first projector that projects image light onto a screen and a support apparatus, in which
the support apparatus includes
a cable holder that holds a cable having one end coupled to the first projector, and
a support section that positions the cable holder with respect to an installation surface at which the first projector is provided,
in the upward vertical direction, the distance from the installation surface to the cable holder is greater than the distance from the installation surface to the top surface of the first projector.

The configuration described in the additional remark 1, in which the cable holder is disposed at a location higher than the installation surface, at which the first projector is provided, allows the cable to be held above the installation surface. The situation in which the cable comes into contact with the installation surface or the floor surface at which the present system is provided can therefore be suppressed. Therefore, it can suppress a problem such as the viewers of an image are caught by the cable routed on the floor surface. Also when the projection system is used outdoors or in a similar situation and moisture or the like has adhered to the floor surface, the problem of leakage of electricity from the moisture having adhered to the floor surface through the cable can be suppressed because the cable is not placed on the floor surface.

### Additional Remark 2

The projection system described in the additional remark 1, in which
a first distance is greater than or equal to a second distance,
the first distance being the distance from the installation surface to the cable holder in the upward vertical direction, the second distance being the distance from the installation surface to the position on the screen that is farthest from the installation surface in the upward vertical direction.

According to the configuration described in the additional remark 2, the cable coupled to the first projector can be held above the screen. Contact of the cable with the floor surface can thus be suppressed.

### Additional Remark 3

The projection system described in the additional remark 1 or 2, further including
an installation base having the installation surface, at which the first projector is provided,
the support section coupled to the installation base.

According to the configuration described in the additional remark 3, since the support section is coupled to the installation base having the installation surface, the environment of the projection system is readily constructed.

### Additional Remark 4

The projection system described in the additional remark 1 or 2, in which
the cable holder includes a shaft that extends along a first direction that intersects with the vertical direction, a rotor that rotates around a first axis of rotation passing through the shaft, and a frame part coupled to the shaft,
the frame part includes a first extending section located at one side of the rotor in the first direction and a second extending section located at the other side of the rotor in the first direction, and
the first and second extending sections protrude beyond the rotor in a second direction along the vertical direction.

According to the configuration described in the additional remark 4, since the rotor rotates as the cable moves, the situation in which the cable is twisted, rubbed, or otherwise stressed can be suppressed. Problems, such as deformation or disconnection of the cable, can thus be suppressed. Furthermore, the protrusions of the first and second extending sections can restrict movement of the cable in the second direction.

### Additional Remark 5

The projection system described in the additional remark 4, in which
the frame part further includes a coupler that couples the first extending section and the second extending section to each other, and
the cable is surrounded by the coupler, the first extending section, the second extending section, and the rotor.

According to the configuration described in the additional remark 5, the cable holder can stably hold the cable without causing the cable to fall off.

### Additional Remark 6

The projection system described in the additional remark 4 or 5, in which
the rotor has a holding surface at which the cable is held, and
the holding surface has a recess recessed toward the shaft in the cross-sectional view taken along the plane containing the first and second directions.

According to the configuration described in the additional remark 6, the cable is stably held in the recess. Therefore, even when the rotor rotates, the cable is less likely to disengage from the rotor.

### Additional Remark 7

The projection system described in the additional remark 6, in which
the surface of the recess is a curved surface having a curvature defined with respect to the first axis of rotation of the rotor.

According to the configuration described in the additional remark 7, the cable having a circular cross-sectional shape is stably held along the surface of the recess formed of the curved surface. Therefore, even when the rotor rotates, a shift of the cable in the second direction along the shaft can be suppressed.

### Additional Remark 8

The projection system described in the additional remark 6 or 7, in which
the rotor has a plurality of the recesses.

According to the configuration described in the additional remark 8, a plurality of cables can be held in the plurality of recesses.

### Additional Remark 9

The projection system described in any one of the additional remarks 3 to 8, in which
the support apparatus further includes a first fixing section and a second fixing section that detachably fix the support section to the installation base.

According to the configuration described in the additional remark 9, since the support section is fixed to the installation base at two positions, the first fixing section and the second fixing section, the support section can be stably fixed to the installation base.

### Additional Remark 10

The projection system described in the additional remark 9, in which
the installation base further includes an attachment section to which the first and second fixing sections are attached, and
the attachment section is fixed to each of a first surface and a second surface of the installation base that are perpendicular to each other.

According to the configuration described in the additional remark 10, the attachment section is attached to the installation base in a stable state with little rattle. The attachment section therefore allows the support apparatus to be attached to the installation base in the stable state without rattle.

### Additional Remark 11

The projection system described in the additional remark 10, in which
the first fixing section includes a first protrusion,
the second fixing section includes a second protrusion, and
the attachment section further includes a first slit opening to which the first protrusion is hooked and a second slit opening to which the second protrusion is hooked.

According to the configuration described in the additional remark 11, hooking the first and second fixing sections to the slit openings of the attachment section of the installation base allows the support apparatus to be readily attached to and detached from the installation base.

### Additional Remark 12

The projection system described in any one of the additional remarks 4 to 8, in which
the cable holder rotates around a second axis of rotation perpendicular to the first axis of rotation.

According to the configuration described in the additional remark 12, the rotation of the cable holder around the second axis of rotation allows the direction in which the cable is drawn by the cable holder to be adjusted to a variety of directions.

### Additional Remark 13

The projection system described in any one of the additional remarks 3 to 11, in which
the support section is a columnar member, and
a part of the outer circumferential surface of the support section is in contact with the installation base.

The configuration described in the additional remark 13, in which a part of the outer circumferential surface of the support section abuts against the installation base, allows further suppression of rattle of the support section.

### Additional Remark 14

The projection system described in any one of the additional remarks 1 to 13, further including
a second projector that projects image light onto the screen in a direction different from the direction in which the first projector projects image light,
the other end of the cable coupled to the first projector being coupled to the second projector.

The configuration described in the additional remark 14, which displays images projected from the two projectors, can provide a system that displays a more complicated, attractive image.

### Additional Remark 15

An installation unit to which a cable is coupled and in which a projector that projects image light is provided, the installation unit including
an installation base having an installation surface at which the projector is provided, and
a support apparatus that is coupled to the installation base and supports the cable,
the support apparatus including a cable holder that holds the cable and a support section that positions the cable holder with respect to the installation surface,
in the upper vertical direction, the distance from the installation surface to the cable holder is greater than the distance from the installation surface to the top surface of the projector.

The configuration described in the additional remark 15, in which the cable holder is disposed at a location higher than the installation surface, at which the projector is provided, allows the cable to be held above the installation surface. The situation in which the cable comes into contact with the installation surface or the floor surface at which the installation unit is provided can therefore be suppressed. Therefore, it can suppress a problem such as the viewers of an image are caught by the cable routed on the floor surface. Also when the projection system is used outdoors or in a similar situation and moisture or the like has adhered to the floor surface, the problem of leakage of electricity from the moisture having adhered to the floor surface through the cable can be suppressed because the cable is not placed on the floor surface.

### Additional Remark 16

A support apparatus used in a projection system including a projector that projects image light onto a screen, the support apparatus including
a cable holder that holds a cable having one end coupled to the projector, and
a support section that positions the cable holder with respect to an installation surface at which the projector is provided,
in the upper vertical direction, the distance from the installation surface to the cable holder is greater than the distance from the installation surface to the top surface of the projector.

The configuration described in the additional remark 16, in which the cable holder is disposed at a location higher than the installation surface, at which the projector is provided, allows the cable to be held above the installation surface. The situation in which the cable comes into contact with the installation surface or the floor surface at which the projection system is provided can therefore be suppressed. Therefore, it can suppress a problem such as the viewers of an image are caught by the cable routed on the floor surface. Also when the projection system is used outdoors or in a similar situation and moisture or the like has adhered to the floor surface, the problem of leakage of electricity from the moisture having adhered to the floor surface through the cable can be suppressed because the cable is not placed on the floor surface.

What is claimed is:

1. A projection system including a first projector that projects image light onto a screen and a support apparatus, wherein
the support apparatus includes
a cable holder that holds a cable having one end coupled to the first projector and
a support section that positions the cable holder with respect to an installation surface at which the first projector is provided, and
in an upward vertical direction, a distance from the installation surface to the cable holder is greater than a distance from the installation surface to a top surface of the first projector.

2. The projection system according to claim 1, wherein
a first distance is greater than or equal to a second distance,
the first distance being the distance from the installation surface to the cable holder in the upward vertical direction, the second distance being a distance from the installation surface to a position on the screen that is farthest from the installation surface in the upward vertical direction.

3. The projection system according to claim 1, further comprising
an installation base having the installation surface, at which the first projector is provided, wherein
the support section is coupled to the installation base.

4. The projection system according to claim 1, wherein
the cable holder includes a shaft that extends along a first direction that intersects with the vertical direction, a rotor that rotates around a first axis of rotation passing through the shaft, and a frame part coupled to the shaft,
the frame part includes a first extending section located at one side of the rotor in the first direction and a second extending section located at another side of the rotor in the first direction, and
the first and second extending sections protrude beyond the rotor in a second direction along the vertical direction.

5. The projection system according to claim 4, wherein
the frame part further includes a coupler that couples the first extending section and the second extending section to each other, and
the cable is surrounded by the coupler, the first extending section, the second extending section, and the rotor.

6. The projection system according to claim 4, wherein
the rotor has a holding surface at which the cable is held, and
the holding surface has a recess recessed toward the shaft in a cross-sectional view taken along a plane containing the first and second directions.

7. The projection system according to claim 6, wherein
a surface of the recess is a curved surface having a curvature defined with respect to the first axis of rotation of the rotor.

8. The projection system according to claim 6, wherein
the rotor has a plurality of the recesses.

9. The projection system according to claim 3, wherein
the support apparatus further includes a first fixing section and a second fixing section that detachably fix the support section to the installation base.

10. The projection system according to claim 9, wherein
the installation base further includes an attachment section to which the first and second fixing sections are attached, and
the attachment section is fixed to each of a first surface and a second surface of the installation base that are perpendicular to each other.

11. The projection system according to claim 10, wherein
the first fixing section includes a first protrusion,
the second fixing section includes a second protrusion, and
the attachment section further has a first slit opening to which the first protrusion is hooked and a second slit opening to which the second protrusion is hooked.

12. The projection system according to claim 4, wherein
the cable holder rotates around a second axis of rotation perpendicular to the first axis of rotation.

13. The projection system according to claim 3, wherein
the support section is a columnar member, and
a part of an outer circumferential surface of the support section is in contact with the installation base.

14. The projection system according to claim 1, further comprising
a second projector that projects image light onto the screen in a direction different from a direction in which the first projector projects image light, wherein
another end of the cable coupled to the first projector is coupled to the second projector.

15. An installation unit to which a cable is coupled and in which a projector that projects image light is provided, the installation unit comprising:
an installation base having an installation surface at which the projector is provided; and
a support apparatus that is coupled to the installation base and supports the cable, wherein
the support apparatus includes a cable holder that holds the cable and a support section that positions the cable holder with respect to the installation surface, and
in an upper vertical direction, a distance from the installation surface to the cable holder is greater than a distance from the installation surface to a top surface of the projector.

16. A support apparatus used in a projection system including a projector that projects image light onto a screen, the support apparatus comprising:
a cable holder that holds a cable having one end coupled to the projector; and
a support section that positions the cable holder with respect to an installation surface at which the projector is provided, wherein
in an upper vertical direction, a distance from the installation surface to the cable holder is greater than a distance from the installation surface to a top surface of the projector.
